(19) United States
(12) Patent Application Publication
(10) Pub. No.: US 2026/0298190 A1
(43) Pub. Date: Oct. 1, 2026

(54) HYDROELECTRIC POWER GENERATION DEVICE AND POWER GENERATION METHOD BASED ON AXIAL-FLOW HYDRAULIC TURBINE

(71) Applicants: HEBEI WATER CONSERVANCY ENGR BUREAU GROUP LIMITED, Shijiazhuang City (CN); Shijiazhuang Tiedao University, Shijiazhuang City (CN); Shijiazhuang Hufu Engineering Co., Ltd., Shijiazhuang City (CN)

(72) Inventors: Bin LIU, Shijiazhuang City (CN); Hongqiang DING, Shijiazhuang City (CN); Liting ZHANG, Shijiazhuang City (CN); Huiqing WANG, Shijiazhuang City (CN); Bo ZHANG, Shijiazhuang City (CN); Jiangbo LIU, Shijiazhuang City (CN); Zhiwei CUI, Shijiazhuang City (CN); Xiang GAO, Shijiazhuang City (CN); Yuanyuan MA, Shijiazhuang City (CN); Haiqiang ZHANG, Shijiazhuang City (CN); Ke CUI, Shijiazhuang City (CN); Xinwei ZHANG, Shijiazhuang City (CN); Jianhui LIU, Shijiazhuang City (CN); Feng GAO, Shijiazhuang City (CN); Yafan LIU, Shijiazhuang City (CN); Zhonglei JIN, Shijiazhuang City (CN); Bochuan GAO, Shijiazhuang City (CN)

(73) Assignees: HEBEI WATER CONSERVANCY ENGR BUREAU GROUP LIMITED, Shijiazhuang City (CN); Shijiazhuang Tiedao University, Shijiazhuang City (CN); Shijiazhuang Hufu Engineering Co., Ltd., Shijiazhuang City (CN)

(21) Appl. No.: 19/447,412

(22) Filed: Jan. 13, 2026

(30) Foreign Application Priority Data
Apr. 1, 2025 (CN) 202510401369.1

(51) Int. Cl. F03B 3/14; F03B 3/06; F03B 3/12; F03B 11/00

(52) U.S. Cl. CPC F03B 3/145; F03B 3/06; F03B 3/126; F03B 11/004; F05B 2210/11; F05B 2240/2021; F05B 2240/242

(57) ABSTRACT

A hydroelectric power generation device and a power generation method based on an axial-flow hydraulic turbine are provided. The hydroelectric power generation device includes a water delivery pipeline. A power generation mechanism is mounted on and is connected to the water delivery pipeline. The power generation mechanism includes a hydraulic pump housing, an axial-flow impeller assembly and a generator. The hydraulic pump housing is mounted on and is connected to the water delivery pipeline. The axial-flow impeller assembly is rotatably mounted inside the hydraulic pump housing, and the generator is securely mounted on one side of an outside of the hydraulic pump housing and is drivingly connected with the axial-flow impeller assembly. The axial-flow impeller assembly includes a rotor, multiple vanes, that are circumferentially distributed, are mounted on an outer peripheral surface of the rotor. A power generation drive shaft is securely mounted at one end of the rotor.

### CROSS-REFERENCE TO RELATED APPLICATION

This patent application claims the benefit and priority of Chinese Patent Application No. 202510401369.1, entitled “HYDROELECTRIC POWER GENERATION DEVICE AND POWER GENERATION METHOD BASED ON AXIAL-FLOW HYDRAULIC TURBINE” filed on Apr. 1, 2025, the disclosure of which is incorporated by reference herein in its entirety as part of the present application.

### TECHNICAL FIELD

The present disclosure belongs to the field of hydroelectric power generation devices, and particularly relates to a hydroelectric power generation device and a power generation method based on an axial-flow hydraulic turbine.

### BACKGROUND

Hydroelectric power generation is a scientific and technological measure for converting water energy into electrical energy, which is studied to solve technical and economic problems such as engineering construction and production operation. The water energy utilized for hydroelectric power generation mainly comes from the potential energy a water body processes; in order to convert water energy into electrical energy, it is required to construct different types of hydropower plants. The basic principle of hydroelectric power generation is that the electricity is generated by utilizing a water height difference in cooperation with a water turbine generator, that is, the electricity is obtained by converting the potential energy of water into the mechanical energy of a water turbine and then using the mechanical energy to propel a generator. Currently, in order to convert water energy into electrical energy, it is required to build different types of hydropower plants on natural water bodies such as rivers, to throttle and divert the rivers and then build facilitates at riverbeds, causing a large engineering amount and long period, and the hydropower plants cannot begin to perform hydroelectric power generation until the construction of the hydropower plants is basically completed. In most cases, known hydroelectric generation is implemented by providing large hydropower plants, but there are still many other hydroelectric resources not used in life.

For example, when water plants supply water, in order to ensure stable water supply, a water supply pressure is typically greater than an actual required water pressure, excessive water head and excessive water flow kinetic energy are then generated, and thus energy loss is caused. In view of this situation, there is a need to provide a device for power generation by using the remaining water head and water flow kinetic energy, and a hydroelectric power generation method.

### SUMMARY

In view of the problems in the related art, the present disclosure provides a hydroelectric power generation device and a power generation method based on an axial-flow hydraulic turbine, so as to overcome the above technical problems in the related art.

In order to solve the above technical problems, the present disclosure provides the following technical solutions.

The present disclosure provides a hydroelectric power generation device, which includes a water delivery pipeline. A power generation mechanism is mounted on and is connected to the water delivery pipeline. The power generation mechanism includes a hydraulic pump housing, an axial-flow impeller assembly and a generator. The hydraulic pump housing is mounted on and is connected to the water delivery pipeline. The axial-flow impeller assembly is rotatably mounted inside the hydraulic pump housing. The generator is securely mounted on one side of an outside of the hydraulic pump housing and is drivingly connected with the axial-flow impeller assembly.

The axial-flow impeller assembly includes a rotor. Multiple vanes, that are circumferentially distributed, are mounted on an outer peripheral surface of the rotor. A power generation drive shaft is securely mounted at one end of the rotor. The power generation drive shaft is drivingly connected with the generator.

An impeller adjustment mechanism is mounted on the rotor. The impeller adjustment mechanism is configured to be capable of adjusting angles of the multiple vanes on the rotor to adjust a hydraulic impact force exerted on the multiple vanes as water in the water delivery pipeline flows through the hydraulic pump housing. Water head loss generated as the water flows through the hydraulic pump housing.

An impeller locking mechanism is further mounted inside the rotor. The impeller locking mechanism is configured to be capable of securing and locking the multiple vanes on the rotor and is configured to be capable of unlocking the vanes when the impeller adjustment mechanism adjusts the angle of the multiple vanes.

Further, the water delivery pipeline comprises a main pipeline and a connecting pipe. Two ends of the connecting pipe communicate with the main pipeline. The hydraulic pump housing is mounted on the connecting pipe. Two ends of the hydraulic pump housing are provided with volute casings for communicating with the connecting pipe.

A first flow regulating valve is connected to and mounted on the main pipeline. The first flow regulating valve is located between a liquid inlet and a liquid outlet of the connecting pipe. Each of the two ends of the connecting pipe is provided with a second flow regulating valve and a flow meter.

Further, the impeller adjustment mechanism includes multiple rotating seats, a transmission shaft and a drive assembly. The multiple rotating seats are rotatably mounted on a side wall of the rotor in a circumferential distribution manner. Each of the multiple vanes is securely mounted at an outer side end of a corresponding one of the multiple rotating seats. A rotating shaft is securely mounted at an inner side end of each of the multiple rotating seats. A driven bevel gear is securely mounted at a tail end of the rotating shaft. The transmission shaft is rotatably mounted at a central axis position of an interior of the rotor. One end of the transmission shaft is drivingly connected with the drive assembly. A transmission bevel gear is securely mounted at an other end of the transmission shaft. Multiple driven bevel gears are connected with the transmission bevel gear in a meshing transmission manner. The drive assembly is configured to be capable of driving the transmission shaft and the transmission bevel gear to rotate, and thus the transmission bevel gear meshingly drives the multiple driven bevel gears to rotate synchronously.

Further, the drive assembly includes an adjustment motor, an adjustment shaft and a clutch unit. The adjustment shaft is rotatably mounted at one end of the rotor and is arranged concentric with the transmission shaft. One end of the adjustment shaft is able to be securely connected with the transmission shaft by means of the clutch unit. An other end of the adjustment shaft extends to the outside of the hydraulic pump housing and is drivingly connected with the adjustment motor.

Further, the clutch unit includes a fixed friction disk and a spline. The fixed friction disk is securely mounted to one end of the transmission shaft. The spline is securely mounted to an inner side end of the adjustment shaft. A movable friction disk is slidably mounted on the spline.

Further, the clutch unit further includes a motor, an inner gear ring and a connecting ring. The connecting ring is rotatably mounted to an outer peripheral surface of the movable friction disk. Multiple connecting rods, that are circumferentially distributed, are securely mounted to an outer peripheral surface of the connecting ring. A threaded bushing is fixedly mounted to an outer side end of each of the multiple connecting rods. The threaded bushing is drivingly mounted with a threaded rod by means of an internal thread. A bottom end of the threaded rod is rotatably connected with an inner wall of the rotor. A transmission gear is securely mounted at a top end of the threaded rod.

The inner gear ring is rotatably mounted on the inner wall of the rotor. The inner gear ring is simultaneously connected with a plurality of transmission gears in a meshing transmission manner. The motor is securely mounted inside the rotor. An output end of the motor is drivingly mounted with a driving gear. The driving gear is connected with the inner gear ring in a meshing transmission manner.

Further, the impeller locking mechanism includes multiple locking seats. The multiple locking seats are securely mounted circumferentially on the inner wall of the rotor. Each of the multiple locking seats is located on an outer peripheral surface of a corresponding rotating shaft. Each of the multiple locking seats is provided with sliding grooves that are circumferentially distributed, and a fixture block is slidably mounted in each of the sliding grooves.

Further, a drive disk located below the fixture block is rotatably mounted inside each of the plurality of locking seats. A top surface of the drive disk is provided with flat threads. A bottom surface of the fixture block is provided with limiting guide grooves slidably snap-fitted with the flat threads. The drive disk is configured to be capable of driving, during rotation, multiple fixture blocks to synchronously move outward along the sliding grooves by means of cooperation of the flat threads and the limiting guide grooves.

An outer peripheral surface of a bottom surface of the drive disk is securely mounted with an end face gear ring. A transmission rod is rotatably mounted on a side wall of each of the multiple locking seats. A driven gear connected with the inner gear ring in a meshing transmission manner is securely mounted at an outer side end of the transmission rod. A drive gear connected with the end face gear ring in a meshing transmission manner is securely mounted at an inner side end of the transmission rod.

Further, a friction plate that is attachable to an outer peripheral surface of the rotating shaft is securely mounted at an inner side end of the fixture block, and the outer peripheral surface of the rotating shaft is provided with friction stripes.

The present disclosure further discloses a power generation method based on an axial-flow hydraulic turbine, including: driving a rotor by the multiple vanes to rotate under impact effect of water flow when the water in the water delivery pipeline flows through the hydraulic pump housing, and the driving the power generation drive shaft by the rotor to rotate synchronously, and thus the power generation drive shaft drives the generator to generate electricity; firstly unlocking the multiple vanes secured and locked by an impeller locking mechanism when a water delivery pressure in the water delivery pipeline is decreased, rotatably adjusting the plurality of vanes by the impeller adjustment mechanism in a horizontal direction to reduce resistance to which the water flowing through the multiple vanes is subjected, and thus the water head loss is reduced; wherein after the adjustment is finished, the multiple vanes are secured and are locked again by the impeller locking mechanism; and rotatably adjusting the multiple vanes by the impeller adjustment mechanism in a vertical direction after the multiple vanes are unlocked, correspondingly, when the water delivery pressure in the water delivery pipeline is increased to increase the impact force exerted on the plurality of vanes as the water flows through the hydraulic pump housing, and thus rotational speeds of the multiple vanes and the rotor are increased.

The embodiments have the following beneficial effects.

According to the embodiments, the power generation mechanism is mounted on the water delivery pipeline of a water plant. When the water in the water delivery pipeline flows through the hydraulic pump housing inside the power generation mechanism, the vanes drive the rotor to rotate under the impact effect of water flow. At this moment, the rotor drives the power generation drive shaft to rotate synchronously, and thus the power generation drive shaft drives the generator to generate electricity. The electricity is generated by using the water head and water flow kinetic energy remaining in the water delivery pipeline of the water plant, such that the energy loss of water flow can be prevented, the efficiency of energy utilization is improved, and sustainable development is facilitated.

According to the embodiments, when the water delivery pressure in the water delivery pipeline is decreased, the vanes are rotatably adjusted by the impeller adjustment mechanism in the horizontal direction to reduce the resistance to which the water flowing through the vanes is subjected, and thus reduce the water head loss. It is ensured that after the water flow in the water delivery pipeline is consumed by the power generation mechanism, the remaining water flow kinetic energy can still allow the normal transmission of the water flow in the pipeline, the water delivery pipeline is accordingly not affected by the power generation mechanism, and stable water supply is ensured. Correspondingly, when the water delivery pressure in the water delivery pipeline is increased, the vanes are rotatably adjusted by the impeller adjustment mechanism in the vertical direction to increase the impact force exerted on the vanes as the water flows through the hydraulic pump housing, and thus the rotational speeds of the vanes and the rotor are increased to improve the power generation capacity of the power generation mechanism. When the water plant supplies water through the water delivery pipeline, the water pressure in the water delivery pipeline is in a fluctuating state due to the impact of the water use of users and other factors, and in this case, the angle of the vanes is adjusted by the impeller adjustment mechanism, such that the power generation capacity of the power generation mechanism can be improved as much as possible while the stable water supply is ensured, and thus the energy loss of the water flow is reduced.

According to the present disclosure, the vanes are secured and locked on the rotor by the impeller locking mechanism, such that the vanes do not rotate by themselves for angle adjustment under the impact action of the water flow, and it is ensured that the vanes can operate normally for hydroelectric power generation. Also, when the angle of the vanes needs to be adjusted, the impeller locking mechanism can unlock the vanes to ensure the normal angle adjustment of the vanes.

Of course, any product implementing the present disclosure does not necessarily need to achieve all of the above advantages simultaneously.

### BRIEF DESCRIPTION OF THE DRAWINGS

In order to illustrate the technical solutions in the embodiments of the present disclosure more clearly, the accommodating drawings that need to be used in the description of the embodiments will be briefly described. Apparently, the drawings in the description below are some embodiments of the present disclosure, and other drawings may be obtained from these drawings without the creative effort of those skilled in the art.

FIG. 1 is a perspective schematic structural diagram of a hydroelectric power generation device according to the present disclosure;

FIG. 2 is a top view of the hydroelectric power generation device according to the present disclosure;

FIG. 3 is a first perspective schematic structural diagram of an axial-flow impeller assembly according to the present disclosure;

FIG. 4 is a second perspective schematic structural diagram of the axial-flow impeller assembly according to the present disclosure;

FIG. 5 is a partially enlarged structural schematic view of part A in FIG. 4 of the present disclosure;

FIG. 6 is a third perspective schematic structural diagram of the axial-flow impeller assembly according to the present disclosure;

FIG. 7 is a partially enlarged structural schematic view of part B in FIG. 6 of the present disclosure;

FIG. 8 is a perspective schematic structural diagram of an impeller locking mechanism according to the present disclosure;

FIG. 9 is a partially enlarged structural schematic view of part C in FIG. 8 of the present disclosure.

List of the reference characters: 1 main pipeline; 2 connecting pipe; 3 flow regulating valve; 4 flow meter; 5 power generation mechanism; 51 hydraulic pump housing; 52 volute casing; 53 power generation drive shaft; 54 generator; 55 rotor; 56 vane; 6 impeller adjustment mechanism; 61 adjustment motor; 62 adjustment shaft; 63 rotating seat; 64 driven bevel gear; 65 transmission bevel gear; 66 motor; 67 transmission shaft; 68 fixed friction disk; 69 movable friction disk; 610 spline; 611 driving gear; 612 inner gear ring; 613 connecting ring; 614 connecting rod; 615 threaded bushing; 616 threaded rod; 617 transmission gear; 618 rotating shaft; 7 impeller locking mechanism; 71 locking seat; 72 transmission rod; 73 driven gear; 74 sliding groove; 75 fixture block; 76 limiting guide groove; 77 friction plate; 78 drive gear; 79 end face gear ring; 710 drive disk; 711 flat thread.

### DETAILED DESCRIPTION OF THE EMBODIMENTS

The technical solutions in the embodiments of the present disclosure will be clearly and completely described below in conjunction with the accompanying drawings in the embodiments of the present disclosure. Apparently, the embodiments described are merely some rather than all of the embodiments of the present disclosure. On the basis of the embodiments of the present disclosure, all other embodiments that can be obtained by those of ordinary skill in the art without creative efforts shall fall within the scope of protection of the present disclosure.

It should be understood that, in the description of the present disclosure, terms “opening”, “up”, “down”, “top”, “middle” and “inside” indicate orientation or position relationships, and are merely used for convenience of describing the present disclosure and simplifying the description, rather than indicating or implying that an indicated apparatus or element needs to have a specific orientation or be constructed and operated in a specific orientation, and therefore cannot be understood as a limitation on the present disclosure.

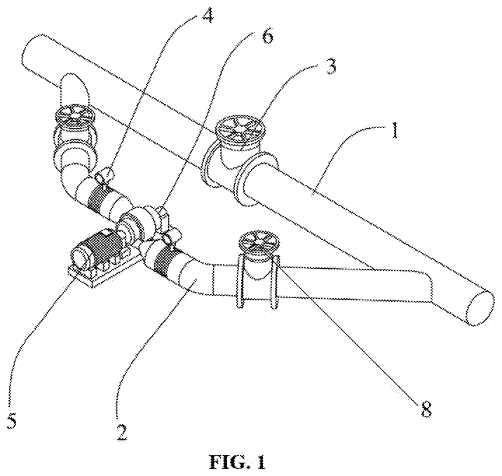

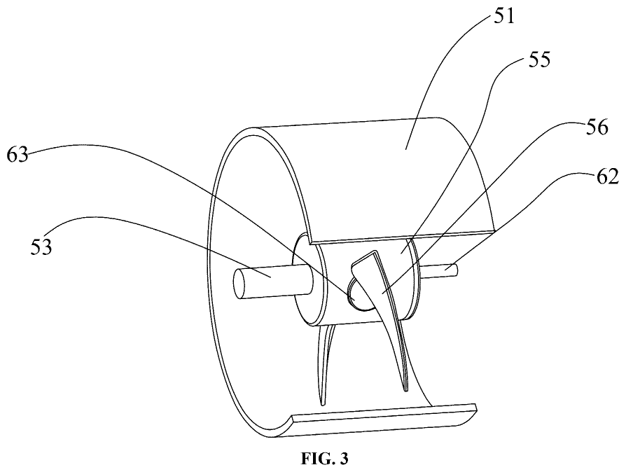

Referring to FIGS. 1-4, one embodiment is depicted, wherein the present disclosure provides a hydroelectric power generation device, which includes a water delivery pipeline. A power generation mechanism 5 is mounted on the water delivery pipeline and is connected with the water delivery pipeline. The power generation mechanism 5 includes a hydraulic pump housing 51, an axial-flow impeller assembly and a generator 54. The hydraulic pump housing 51 is mounted on the water delivery pipeline and is connected with the water delivery pipeline. The axial-flow impeller assembly is rotatably mounted inside the hydraulic pump housing 51, and the generator 54 is securely mounted on one side of the outside of the hydraulic pump housing 51 and is drivingly connected with the axial-flow impeller assembly. The axial-flow impeller assembly includes a rotor 55. Multiple circumferentially distributed vanes 56 are mounted on an outer peripheral surface of the rotor 55. A power generation drive shaft 53 is securely mounted at one end of the rotor 55, and the power generation drive shaft 53 is drivingly connected with the generator 54. An impeller adjustment mechanism 6 is mounted on the rotor 55. The impeller adjustment mechanism 6 can adjust the angle of the vanes 56 on the rotor 55 to adjust the hydraulic impact force exerted on the vanes 56 as the water in the water delivery pipeline flows through the hydraulic pump housing 51, and the water head loss generated as the water flows through the hydraulic pump housing 51. An impeller locking mechanism 7 is further mounted inside the rotor 55, and the impeller locking mechanism 7 can secure and lock the vanes 56 on the rotor 55 and can unlock the vanes 56 when the impeller adjustment mechanism 6 adjusts the angle of the vanes 56.

The water delivery pipeline is a water delivery pipeline of a water plant. When the water in the water delivery pipeline flows through the hydraulic pump housing 51, the vanes 56 drive the rotor 55 to rotate under the impact effect of water flow, and at this moment, the rotor 55 drives the power generation drive shaft 53 to rotate synchronously, and thus the power generation drive shaft 53 drives the generator 54 to generate electricity. When a water delivery pressure in the water delivery pipeline is decreased, the vanes 56 secured and locked by the impeller locking mechanism 7 are firstly unlocked, the vanes 56 are then rotatably adjusted by the impeller adjustment mechanism 6 in a horizontal direction to reduce the resistance to which the water flowing through the vanes 56 is subjected, and thus the water head loss is reduced; after the adjustment is finished, the vanes 56 are secured and locked again by the impeller locking mechanism 7. Correspondingly, when the water delivery pressure in the water delivery pipeline is increased, the vanes 56 are rotatably adjusted by the impeller adjustment mechanism 6 in a vertical direction after the vanes 56 are unlocked to increase the impact force exerted on the vanes 56 as the water flows through the hydraulic pump housing 51, the rotational speeds of the vanes 56, the rotor 55 and the power generation drive shaft 53 are then increased, and thus the power generation capacity is improved.

The electricity is generated by using the water head and water flow kinetic energy remaining in the water delivery pipeline of the water plant, such that the energy loss of water flow can be prevented, the efficiency of energy utilization is improved, and sustainable development is facilitated. When the water plant supplies water through the water delivery pipeline, the water pressure in the water delivery pipeline is in a fluctuating state due to the impact of the water use of users and other factors. And in this case, the angle of the vanes 56 is adjusted correspondingly by the impeller adjustment mechanism 6, such that the power generation capacity of the power generation mechanism 5 can be improved as much as possible while the stable water supply is ensured, and the energy loss of the water flow is thus reduced. The vanes 56 are secured and locked on the rotor 55 by the impeller locking mechanism 7, such that the vanes 56 do not rotate by themselves and become loose under the impact action of the water flow, and it is ensured that the vanes 56 can operate normally for hydroelectric power generation. Also, when the angle of the vanes 56 needs to be adjusted, the impeller locking mechanism 7 can unlock the vanes 56 to ensure the normal angle adjustment of the vanes 56.

In another embodiment, referring to FIGS. 1-3, the differences between this embodiment and the above embodiment lie in that: the water delivery pipeline includes a main pipeline 1 and a connecting pipe 2, two ends of the connecting pipe 2 communicate with the main pipeline 1, the hydraulic pump housing 51 is mounted on the connecting pipe 2, and two ends of the hydraulic pump housing 51 are provided with volute casings 52 for communicating with the connecting pipe 2. A flow regulating valve 3 is mounted on the main pipeline 1 and is connected with the main pipeline 1, the flow regulating valve 3 is located between a liquid inlet and a liquid outlet of the connecting pipe 2, and each of the two ends of the connecting pipe 2 is provided with a flow regulating valve 3 and a flow meter 4.

The main pipeline 1 is a water delivery pipeline of the water plant. By adding the connecting pipe 2 and the power generation mechanism 5 to the main pipeline 1, the power generation mechanism 5 is more convenient to mount and connect. When hydroelectric power generation is carried out, the flow regulating valve 3 on the main pipeline 1 is closed, the flow regulating valve 3 on the connecting pipe 2 is opened, and thus water in the main pipeline 1 flows through the connecting pipe 2 and the power generation mechanism 5 to generate electricity. The flow meters 4 at two ends of the power generation mechanism 5 are configured for measuring the water flows before and after power generation, and are configured for adjusting the angle of the vane 56 in cooperation with the impeller adjustment mechanism 6 to allow the vanes 56 to be at an appropriate power generation angle.

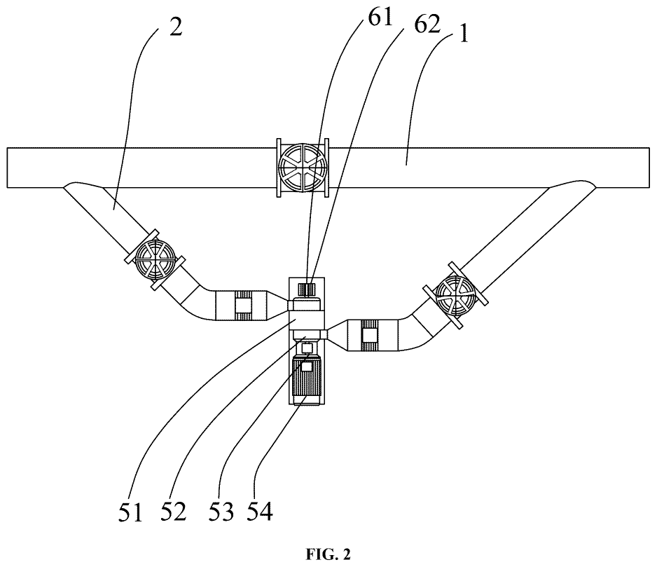

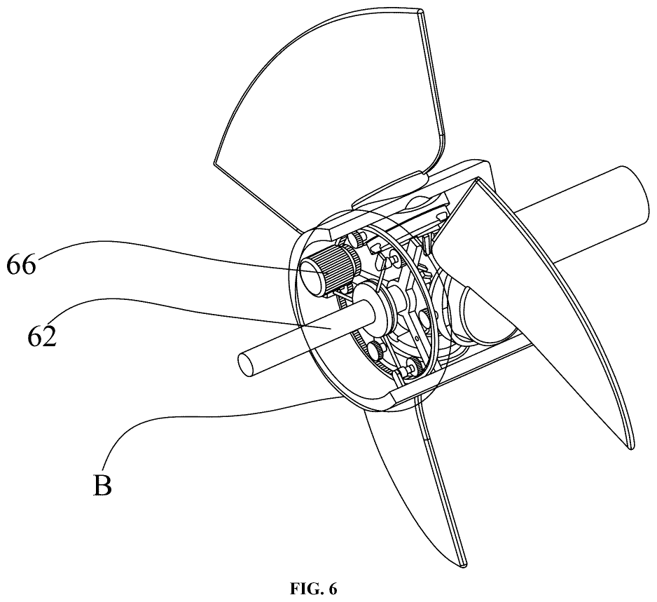

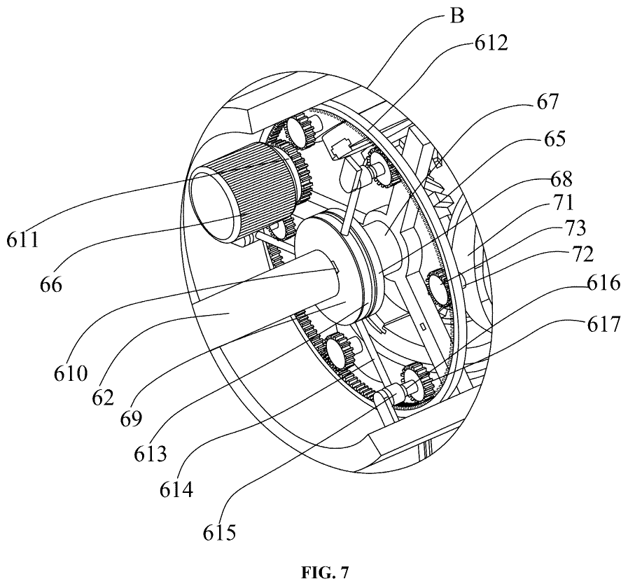

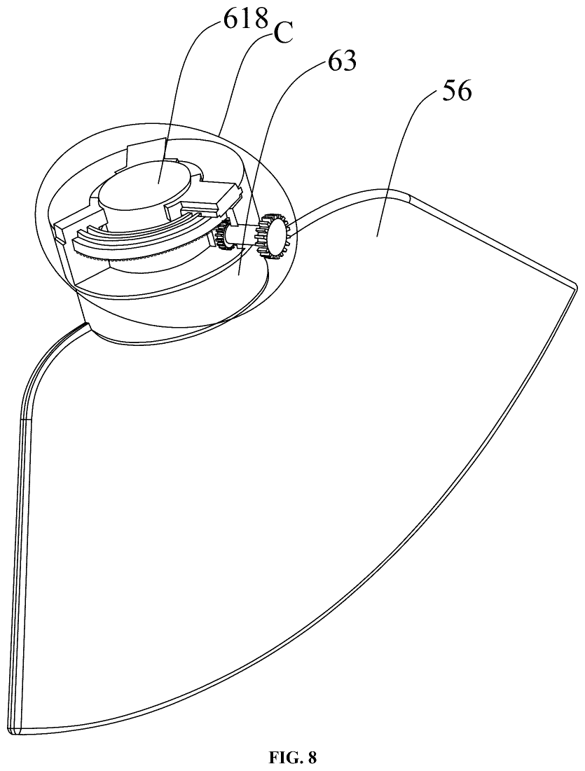

In a further embodiment, referring to FIGS. 2-8, the differences between this embodiment and the above embodiment lie in that: the impeller adjustment mechanism 6 includes multiple rotating seats 63, a transmission shaft 67 and a drive assembly. The multiple rotating seats 63 are rotatably mounted on the side wall of the rotor 55 in a circumferential distribution manner. The vanes 56 are securely mounted at the outer side ends of the rotating seats 63. Rotating shafts 618 are securely mounted at the inner side ends of the rotating seats 63, and driven bevel gears 64 are securely mounted at the tail ends of the rotating shafts 618. The transmission shaft 67 is rotatably mounted at the central axis position of the interior of the rotor 55. One end of the transmission shaft 67 is drivingly connected with the drive assembly. A transmission bevel gear 65 is securely mounted at the other end of the transmission shaft 67. Multiple driven bevel gears 64 are connected with the transmission bevel gear 65 in a meshing transmission manner. The drive assembly can drive the transmission shaft 67 and the transmission bevel gear 65 to rotate, and thus the transmission bevel gear 65 meshingly drives the multiple driven bevel gears 64 to rotate synchronously.

The drive assembly includes an adjustment motor 61, an adjustment shaft 62 and a clutch unit. The adjustment shaft 62 is rotatably mounted at one end of the rotor 55 and is arranged concentric with the transmission shaft 67. One end of the adjustment shaft 62 can be securely connected with the transmission shaft 67 by means of the clutch unit, and the other end of the adjustment shaft 62 extends to the outside of the hydraulic pump housing 51 and is drivingly connected with the adjustment motor 61.

When the angle of the vanes 56 is adjusted, the adjustment motor 61 drives the adjustment shaft 62 to rotate, the adjustment shaft 62 drives the transmission shaft 67 to rotate synchronously by means of the clutch unit, and thus the transmission shaft 67 drives the transmission bevel gear 65 to rotate. The transmission bevel gear 65 meshingly drives the multiple driven bevel gears 64 to rotate synchronously, and thus the multiple driven bevel gears 64 respectively drive the corresponding rotating shafts 618 and the corresponding rotating seats 63 to rotate synchronously. At this moment, the rotating seats 63 drive the multiple vanes 56 to rotate synchronously so as to simultaneously adjust the angle of the multiple vanes 56, such that it cannot only be more convenient to adjust the angle of the vane 56, and it can also be ensured that the multiple vanes 56 are always at the same angle, and that the multiple vanes 56 are more evenly stressed when subjected to the impact of water flow. After the angle adjustment of the vanes 56 is finished, the adjustment shaft 62 is disconnected from the transmission shaft 67 by means of the clutch unit, the rotor 55 thus rotates to generate electricity, driving the driven bevel gears 64 to perform a circular movement. Accordingly, when the driven bevel gears 64 meshingly drive the transmission bevel gear 65 and the transmission shaft 67 to rotate, the transmission shaft 67 does not drive the adjustment shaft 62 and the adjustment motor 61 to rotate, and thus the energy loss of the rotor 55 during rotation is reduced, which is conducive to improving the power generation effect of the rotor 55 during rotation.

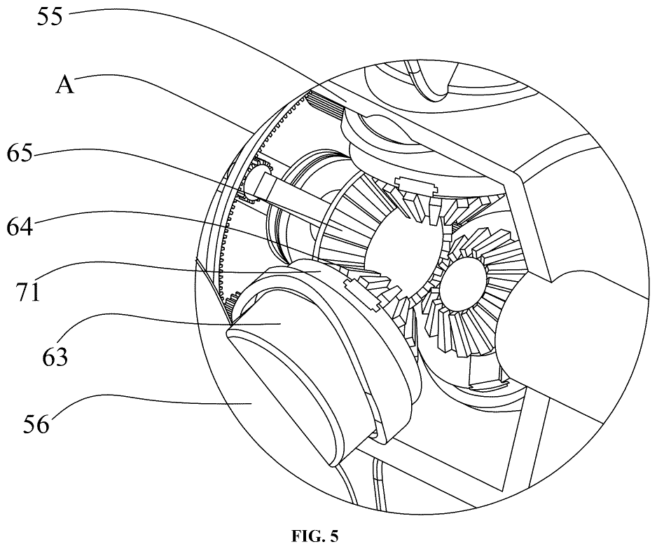

In a further embodiments, referring to FIGS. 5-7, the differences between this embodiment and the above embodiment lie in that: the clutch unit includes a fixed friction disk 68 and a spline 610, the fixed friction disk 68 is securely mounted to one end of the transmission shaft 67, the spline 610 is securely mounted to the inner side end of the adjustment shaft 62, and a movable friction disk 69 is slidably mounted on the spline 610. The clutch unit further includes a motor 66, an inner gear ring 612 and a connecting ring 613. The connecting ring 613 is rotatably mounted to an outer peripheral surface of the movable friction disk 69. Multiple circumferentially distributed connecting rods 614 are securely mounted to an outer peripheral surface of the connecting ring 613. A threaded bushing 615 is fixedly mounted to the outer side end of the connecting rod 614. The threaded bushing 615 is drivingly mounted with a threaded rod 616 by means of an internal thread. The bottom end of the threaded rod 616 is rotatably connected with the inner wall of the rotor 55, and a transmission gear 617 is securely mounted at the top end of the threaded rod 616.

The inner gear ring 612 is rotatably mounted on the inner wall of the rotor 55. The inner gear ring 612 is simultaneously connected with multiple transmission gears 617 in a meshing transmission manner. The motor 66 is securely mounted inside the rotor 55. An output end of the motor 66 is drivingly mounted with a driving gear 611, and the driving gear 611 is connected with the inner gear ring 612 in a meshing transmission manner.

When the angle of the vanes 56 is adjusted, the motor 66 drives the driving gear 611 to rotate. At this moment, the driving gear 611 meshingly drives the inner gear ring 612 to rotate, the inner gear ring 612 meshingly drives, during rotation, the multiple transmission gears 617 to rotate synchronously, and thus the transmission gears 617 drive the threaded rods 616 to rotate synchronously. Each threaded rod 616 drives, during rotation, the threaded bushing 615 thereon to move upward by means of thread transmission. Meanwhile, the threaded bushing 615 drives the movable friction disk 69 by means of the connecting rod 614 and the connecting ring 613 to move upward along the spline 610, and thus the movable friction disk 69 is moved and closely attached to one side of the fixed friction plate 68. Later, when the adjustment shaft 62 rotates, the adjustment shaft 62 drives the movable friction disk 69 to rotate synchronously by means of the spline 610. At this moment, the movable friction disk 69 drives the fixed friction disk 68 to rotate synchronously by means of a friction force, and thus the transmission shaft 67 and the transmission bevel gear 65 are driven to rotate, driving the vanes 56 for angle adjustment.

After the angle adjustment of the vanes 56 is finished, the motor 66 drives the driving gear 611 to rotate reversely. At this moment, the driving gear 611 meshingly drives the inner gear ring 612 to rotate reversely, then the inner gear ring 612 meshingly drives the multiple transmission gears 617 to simultaneously rotate reversely, and thus each transmission gear 617 drives the threaded rod 616 to rotate reversely. Each threaded rod 616 drives, during reverse rotation, the threaded bushing 615 thereon to move downward by means of thread transmission. Meanwhile, the threaded bushing 615 drives the movable friction disk 69 by means of the connecting rod 614 and the connecting ring 613 to move downward along the spline 610, then the movable friction disk 69 is separated from the fixed friction plate 68, and the rotor 55 later rotates to generate electricity, allowing the transmission shaft 67 to rotate, while the transmission shaft 67 does not drive the adjustment shaft 62 to rotate, in order to reduce mechanical losses at the time of power generation.

When the outer peripheral surface of the movable friction disk 69 adjusts the movement of the movable friction disk 69 by means of the cooperation of the connecting ring 613 and the multiple connecting rods 614. The movable friction disk 69 is thus more stable during the mounting and movement adjustment. The movable friction disk 69 can be closely attached to one side of the fixed friction disk 68 when attached to the fixed friction disk 68, and thus the stability of frictional connection between the movable friction disk 69 and the fixed friction disk 68 is ensured. Moreover, by means of the cooperation of the inner gear ring 612, the transmission gear 617, the threaded rod 616 and the threaded bushing 615, the multiple connecting rods 614 can be driven to move synchronously, the movable friction disk 69 are then driven to move, and thus it is more convenient to adjust the movement of the movable friction disk 69.

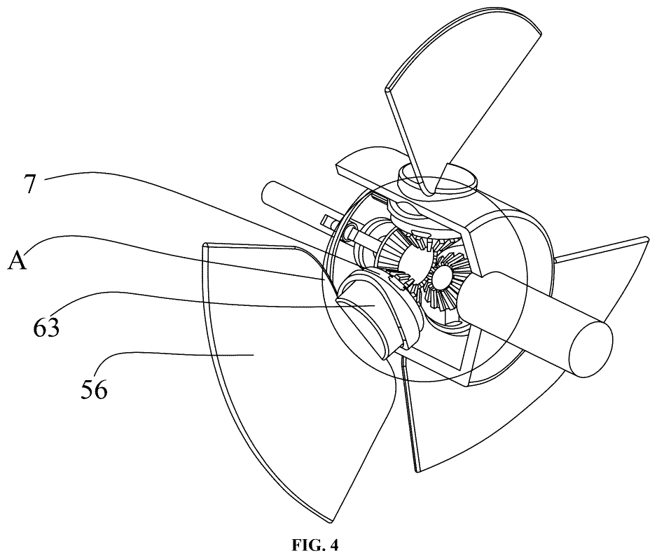

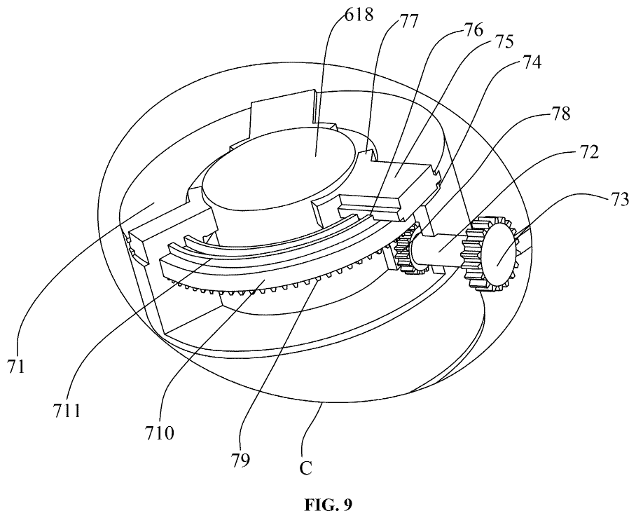

In an additional embodiment, referring to FIGS. 4-9, the differences between this embodiment and the above embodiment lie in that: the impeller locking mechanism 7 includes multiple locking seats 71, the multiple locking seats 71 are securely mounted circumferentially on the inner wall of the rotor 55, each locking seat 71 is located on an outer peripheral surface of the corresponding rotating shaft 618, the locking seat 71 is provided with circumferentially distributed sliding grooves 74, and a fixture block 75 is slidably mounted in the sliding groove 74, A drive disk 710 located below the fixture block 75 is rotatably mounted inside the locking seat 71. The top surface of the drive disk 710 is provided with flat threads 711. The bottom surface of the fixture block 75 is provided with limiting guide grooves 76 slidably snap-fitted with the flat threads 711, and the drive disk 710 can drive, during rotation, multiple fixture blocks 75 to synchronously move outward along the sliding grooves 74 by means of the cooperation of the flat threads 711 and the limiting guide grooves 76.

The outer peripheral surface of the bottom surface of the drive disk 710 is fixedly mounted with an end face gear ring 79. A transmission rod 72 is rotatably mounted on the side wall of the locking seat 71. A driven gear 73 connected with the inner gear ring 612 in a meshing transmission manner is securely mounted at the outer side end of the transmission rod 72, and a drive gear 78 connected with the end face gear ring 79 in a meshing transmission manner is securely mounted at the inner side end of the transmission rod 72.

The fixture block 75 centralizes the rotating shaft 618 for the fixture and locking of the rotating shaft 618, and the corresponding rotating seat 63 and the corresponding vane 56 are then locked and fixed. When the inner gear ring 612 rotatably drives the movable friction disk 69 to be attached to the fixed friction disk 68 prior to the angle adjustment of the vane 56. The inner gear ring 612 drives all the driven gears 73 to rotate synchronously. At this moment, each driven gear 73 drives, by means of the transmission rod 72, the drive gear 78 to rotate synchronously, and thus the drive gear 78 meshingly drives the end face gear ring 79 and the drive disk 710 to rotate. aso, by means of the cooperation of the flat threads 711 and the limiting guide grooves 76, the drive disk 710 drives, during rotation, the multiple fixture blocks 75 to simultaneously move outward along the sliding grooves 74 for opening, the fixture blocks 75 then release the fixed and locked rotating shafts 618, and thus the subsequent angle adjustment of the rotating shafts 618 and the vanes 56 is facilitated. Moreover, after the angle adjustment of the vanes 56 is finished, the inner gear ring 612 rotates reversely to drive the movable friction disk 69 to be separated from the fixed friction disk 68, the inner gear ring 612 drives the multiple driven gears 73 to synchronously rotate reversely. At this moment, each driven gear 73 drives, by means of the transmission rod 72, the drive gear 78 to rotate reversely, and thus the drive gear 78 meshingly drives the end face gear ring 79 and the drive disk 710 to rotate reversely. Also, by means of the cooperation of the flat threads 711 and the limiting guide grooves 76, the drive disk 710 drives, during reverse rotation, the multiple fixture blocks 75 to simultaneously move inward along the sliding grooves 74 for closeup, the multiple fixture blocks 75 then cooperatively centralize the rotating shafts 618 for fixture, and thus the rotating shafts 618 and the vanes 56 are fixed and locked again.

Still further, a friction plate 77 which can be attached to the outer peripheral surface of the rotating shaft 618 is securely mounted at the inner side end of the fixture block 75. The outer peripheral surface of the rotating shaft 618 is provided with friction stripes, and by means of the cooperation of the friction plate 77 and the friction stripes, a locking action force of the fixture block 75 can be increased when fixing and locking the rotating shaft 618, and thus the locking action on the vane 56 can be improved.

In an additional embodiment, a power generation method is disclosed that is based on an axial-flow hydraulic turbine, wherein the power generation method includes the following specific steps. When the water in the water delivery pipeline flows through the hydraulic pump housing 51, the vanes 56 drive the rotor 55 to rotate under the impact effect of the water flow, at this moment, the rotor 55 drives the power generation drive shaft 53 to rotate synchronously, and thus the power generation drive shaft 53 drives the generator 54 to generate electricity. When a water delivery pressure in the water delivery pipeline is decreased, the vanes 56 secured and locked by the impeller locking mechanism 7 are firstly unlocked, the vanes 56 are then rotatably adjusted by the impeller adjustment mechanism 6 in the horizontal direction to reduce the resistance to which the water flowing through the vanes 56 is subjected, and thus the water head loss is reduced. After the adjustment is finished, the vanes 56 are secured and locked again by the impeller locking mechanism 7. Correspondingly, when the water delivery pressure in the water delivery pipeline is increased, the vanes 56 are rotatably adjusted by the impeller adjustment mechanism 6 in the vertical direction after the vanes 56 are unlocked to increase the impact force exerted on the vanes 56 as the water flows through the hydraulic pump housing 51, and thus the rotational speeds of the vanes 56 and the rotor 55 are increased.

In the description of this specification, the expressions with reference to the terms such as “an embodiment”, “example” and “specific example” mean that specific features, structures, materials, or characteristics described with reference to the embodiment or example are included in at least one embodiment or example of the present disclosure. In this specification, schematic description of the above terms does not necessarily refer to the same embodiment or example. Furthermore, the described particular features, structures, materials or characteristics can be integrated with any one or more embodiments or examples in a proper manner.

The above preferred embodiments of the present disclosure are merely intended to help understand the description of the present disclosure. The preferred embodiments neither describe all details elaborately, nor limit the present disclosure to be merely the specific implementation. Apparently, many modifications and changes can be made according to the contents of this specification. These embodiments are selected and described in this specification to better explain the principles and practical applications of the present disclosure, such that those skilled in the art can make good understanding and use of the present disclosure.

1. A hydroelectric power generation device, comprising:
a water delivery pipeline, wherein a power generation mechanism is mounted on and is connected to the water delivery pipeline, the power generation mechanism comprises a hydraulic pump housing, an axial-flow impeller assembly and a generator, the hydraulic pump housing is mounted on and is connected to the water delivery pipeline, the axial-flow impeller assembly is rotatably mounted inside the hydraulic pump housing, and the generator is securely mounted on one side of an outside of the hydraulic pump housing and is drivingly connected with the axial-flow impeller assembly;
the axial-flow impeller assembly comprises a rotor, a plurality of vanes, that are circumferentially distributed, are mounted on an outer peripheral surface of the rotor, a power generation drive shaft is securely mounted at one end of the rotor, and the power generation drive shaft is drivingly connected with the generator;
an impeller adjustment mechanism is mounted on the rotor, the impeller adjustment mechanism is configured to be capable of adjusting angles of the plurality of vanes on the rotor to adjust a hydraulic impact force exerted on the plurality of vanes as water in the water delivery pipeline flows through the hydraulic pump housing, and water head loss generated as the water flows through the hydraulic pump housing; and
an impeller locking mechanism is further mounted inside the rotor, and the impeller locking mechanism is configured to be capable of securing and locking the plurality of vanes on the rotor and is configured to be capable of unlocking the vanes when the impeller adjustment mechanism adjusts the angle of the plurality of vanes;
wherein the impeller adjustment mechanism comprises a plurality of rotating seats, a transmission shaft and a drive assembly; the plurality of rotating seats are rotatably mounted on a side wall of the rotor in a circumferential distribution manner, each of the plurality of vanes is securely mounted at an outer side end of a corresponding one of the plurality of rotating seats, a rotating shaft is securely mounted at an inner side end of each of the plurality of rotating seats, and a driven bevel gear is securely mounted at a tail end of the rotating shaft; the transmission shaft is rotatably mounted at a central axis position of an interior of the rotor, one end of the transmission shaft is drivingly connected with the drive assembly, a transmission bevel gear is securely mounted at an other end of the transmission shaft, and a plurality of driven bevel gears are connected with the transmission bevel gear in a meshing transmission manner;
the drive assembly is configured to be capable of driving the transmission shaft and the transmission bevel gear to rotate, and thus the transmission bevel gear meshingly drives the plurality of driven bevel gears to rotate synchronously.

2. The hydroelectric power generation device according to claim 1, wherein the water delivery pipeline comprises a main pipeline and a connecting pipe, two ends of the connecting pipe communicate with the main pipeline, the hydraulic pump housing is mounted on the connecting pipe, and two ends of the hydraulic pump housing are provided with volute casings for communicating with the connecting pipe; and
a first flow regulating valve is connected to and mounted on the main pipeline, the first flow regulating valve is located between a liquid inlet and a liquid outlet of the connecting pipe, and each of the two ends of the connecting pipe is provided with a second flow regulating valve and a flow meter.

3. (canceled)

4. The hydroelectric power generation device according to claim 1, wherein the drive assembly comprises an adjustment motor, an adjustment shaft and a clutch unit, the adjustment shaft is rotatably mounted at one end of the rotor and is arranged concentric with the transmission shaft, one end of the adjustment shaft is able to be securely connected with the transmission shaft by means of the clutch unit, and an other end of the adjustment shaft extends to the outside of the hydraulic pump housing and is drivingly connected with the adjustment motor.

5. The hydroelectric power generation device according to claim 4, wherein the clutch unit comprises a fixed friction disk and a spline, the fixed friction disk is securely mounted to one end of the transmission shaft, the spline is securely mounted to an inner side end of the adjustment shaft, and a movable friction disk is slidably mounted on the spline.

6. The hydroelectric power generation device according to claim 5, wherein the clutch unit further comprises a motor, an inner gear ring and a connecting ring, the connecting ring is rotatably mounted to an outer peripheral surface of the movable friction disk, a plurality of connecting rods, that are circumferentially distributed, are securely mounted to an outer peripheral surface of the connecting ring, a threaded bushing is fixedly mounted to an outer side end of each of the plurality of connecting rods, the threaded bushing is drivingly mounted with a threaded rod by means of an internal thread, a bottom end of the threaded rod is rotatably connected with an inner wall of the rotor, and a transmission gear is securely mounted at a top end of the threaded rod; and
the inner gear ring is rotatably mounted on the inner wall of the rotor, the inner gear ring is simultaneously connected with a plurality of transmission gears in a meshing transmission manner, the motor is securely mounted inside the rotor, and an output end of the motor is drivingly mounted with a driving gear, and the driving gear is connected with the inner gear ring in a meshing transmission manner.

7. The hydroelectric power generation device according to claim 6, wherein the impeller locking mechanism comprises a plurality of locking seats, the plurality of locking seats are securely mounted circumferentially on the inner wall of the rotor, each of the plurality of locking seats is located on an outer peripheral surface of a corresponding rotating shaft, each of the plurality of locking seats is provided with sliding grooves that are circumferentially distributed, and a fixture block is slidably mounted in each of the sliding grooves.

8. The hydroelectric power generation device according to claim 7, wherein a drive disk located below the fixture block is rotatably mounted inside each of the plurality of locking seats, a top surface of the drive disk is provided with flat threads, a bottom surface of the fixture block is provided with limiting guide grooves slidably snap-fitted with the flat threads, and the drive disk is configured to be capable of driving, during rotation, a plurality of fixture blocks to synchronously move outward along the sliding grooves by means of cooperation of the flat threads and the limiting guide grooves; and
an outer peripheral surface of a bottom surface of the drive disk is securely mounted with an end face gear ring, a transmission rod is rotatably mounted on a side wall of each of the plurality of locking seats, a driven gear connected with the inner gear ring in a meshing transmission manner is securely mounted at an outer side end of the transmission rod, and a drive gear connected with the end face gear ring in a meshing transmission manner is securely mounted at an inner side end of the transmission rod.

9. The hydroelectric power generation device according to claim 8, wherein a friction plate that is attachable to an outer peripheral surface of the rotating shaft is securely mounted at an inner side end of the fixture block, and the outer peripheral surface of the rotating shaft is provided with friction stripes.

10. A power generation method based on an axial-flow hydraulic turbine, which adopts the hydroelectric power generation device as claimed claim 1, wherein the method comprises:
driving a rotor by the plurality of vanes to rotate under impact effect of water flow when the water in the water delivery pipeline flows through the hydraulic pump housing, and the driving the power generation drive shaft by the rotor to rotate synchronously, and thus the power generation drive shaft drives the generator to generate electricity;
firstly unlocking the plurality of vanes secured and locked by an impeller locking mechanism when a water delivery pressure in the water delivery pipeline is decreased, rotatably adjusting the plurality of vanes by the impeller adjustment mechanism in a horizontal direction to reduce resistance to which the water flowing through the plurality of vanes is subjected, and thus the water head loss is reduced; wherein after the adjustment is finished, the plurality of vanes are secured and are locked again by the impeller locking mechanism; and
rotatably adjusting the plurality of vanes by the impeller adjustment mechanism in a vertical direction after the plurality of vanes are unlocked, correspondingly, when the water delivery pressure in the water delivery pipeline is increased to increase the impact force exerted on the plurality of vanes as the water flows through the hydraulic pump housing, and thus rotational speeds of the plurality of vanes and the rotor are increased.

11. The power generation method based on an axial-flow hydraulic turbine according to claim 10, wherein the water delivery pipeline comprises a main pipeline and a connecting pipe, two ends of the connecting pipe communicate with the main pipeline, the hydraulic pump housing is mounted on the connecting pipe, and two ends of the hydraulic pump housing are provided with volute casings for communicating with the connecting pipe; and
a first flow regulating valve is connected to and mounted on the main pipeline, the first flow regulating valve is located between a liquid inlet and a liquid outlet of the connecting pipe, and each of the two ends of the connecting pipe is provided with a second flow regulating valve and a flow meter.

12. canceled

13. The power generation method based on an axial-flow hydraulic turbine according to claim 10, wherein the drive assembly comprises an adjustment motor, an adjustment shaft and a clutch unit, the adjustment shaft is rotatably mounted at one end of the rotor and is arranged concentric with the transmission shaft, one end of the adjustment shaft is able to be securely connected with the transmission shaft by means of the clutch unit, and an other end of the adjustment shaft extends to the outside of the hydraulic pump housing and is drivingly connected with the adjustment motor.

14. The power generation method based on an axial-flow hydraulic turbine according to claim 13, wherein the clutch unit comprises a fixed friction disk and a spline, the fixed friction disk is securely mounted to one end of the transmission shaft, the spline is securely mounted to an inner side end of the adjustment shaft, and a movable friction disk is slidably mounted on the spline.

15. The power generation method based on an axial-flow hydraulic turbine according to claim 14, wherein the clutch unit further comprises a motor, an inner gear ring and a connecting ring, the connecting ring is rotatably mounted to an outer peripheral surface of the movable friction disk, a plurality of connecting rods, that are circumferentially distributed, are securely mounted to an outer peripheral surface of the connecting ring, a threaded bushing is fixedly mounted to an outer side end of each of the plurality of connecting rods, the threaded bushing is drivingly mounted with a threaded rod by means of an internal thread, a bottom end of the threaded rod is rotatably connected with an inner wall of the rotor, and a transmission gear is securely mounted at a top end of the threaded rod; and
the inner gear ring is rotatably mounted on the inner wall of the rotor, the inner gear ring is simultaneously connected with a plurality of transmission gears in a meshing transmission manner, the motor is securely mounted inside the rotor, and an output end of the motor is drivingly mounted with a driving gear, and the driving gear is connected with the inner gear ring in a meshing transmission manner.

16. The power generation method based on an axial-flow hydraulic turbine according to claim 15, wherein the impeller locking mechanism comprises a plurality of locking seats, the plurality of locking seats are securely mounted circumferentially on the inner wall of the rotor, each of the plurality of locking seats is located on an outer peripheral surface of a corresponding rotating shaft, each of the plurality of locking seats is provided with sliding grooves that are circumferentially distributed, and a fixture block is slidably mounted in each of the sliding grooves.

17. The power generation method based on an axial-flow hydraulic turbine according to claim 16, wherein a drive disk located below the fixture block is rotatably mounted inside each of the plurality of locking seats, a top surface of the drive disk is provided with flat threads, a bottom surface of the fixture block is provided with limiting guide grooves slidably snap-fitted with the flat threads, and the drive disk is configured to be capable of driving, during rotation, a plurality of fixture blocks to synchronously move outward along the sliding grooves by means of cooperation of the flat threads and the limiting guide grooves; and
an outer peripheral surface of a bottom surface of the drive disk is securely mounted with an end face gear ring, a transmission rod is rotatably mounted on a side wall of each of the plurality of locking seats, a driven gear connected with the inner gear ring in a meshing transmission manner is securely mounted at an outer side end of the transmission rod, and a drive gear connected with the end face gear ring in a meshing transmission manner is securely mounted at an inner side end of the transmission rod.

18. The power generation method based on an axial-flow hydraulic turbine according to claim 17, wherein a friction plate that is attachable to an outer peripheral surface of the rotating shaft is securely mounted at an inner side end of the fixture block, and the outer peripheral surface of the rotating shaft is provided with friction stripes.
